(19) United States
(12) Patent Application Publication
(10) Pub. No.: US 2003/0018957 A1
(43) Pub. Date: Jan. 23, 2003

(54) Debugger monitor with anticipatory highlights

(75) Inventors: Cary Lee Bates, Rochester, MN (US); William Jon Schmidt, Rochester, MN (US)

Correspondence Address: Gero G. McClellan, Thomason, Moser & Patterson, L.L.P., 3040 Post Oak Boulevard, Suite 1500, Houston, TX, 77056-6582, US

(73) Assignee: International Business Machines Corporation, Armonk, NY

(21) Appl. No.: 09/887,622

(22) Filed: Jun. 22, 2001

(51) Int. Cl. G06F 9/44

(52) U.S. Cl. 717/129

(57) ABSTRACT

A method, apparatus and article of manufacture for displaying computer program variables on a display device when debugging the computer program. In general, the executable status of variables is determined. The variables are then displayed on a display device in manner to differentiate the different executable statuses of the variables. In one embodiment, a first executable status indicates that a variable can change value when the computer program is executing. In another embodiment, a second executable status indicates that a current value of a variable may have a use.

### BACKGROUND OF THE INVENTION

1. Field of the Invention

The present invention generally relates to computers and computer software. More specifically, the invention is generally related to debugging software.

2. Description of the Related Art

Inherent in any software development technique is the potential for introducing “bugs”. A bug will typically cause unexpected results during the execution of the program. Locating, analyzing, and correcting bugs in a computer program is a process known as “debugging”. Debugging of programs may be either done manually or interactively by a debugging system mediated by a computer system. Manual debugging of a program requires a programmer to manually trace the logic flow of the program and the contents of memory elements, e.g., registers and variables. In the interactive debugging of programs, the program is executed under the control of a monitor program (known as a “debugger”), commonly located on and executed by the same computer system on which the program is executed.

Conventionally, debuggers have monitor windows displayed on a user interface that contain a list of variables. Variables hold values that can change when a program is executed and can be special variables, such as local variables for the current method, or can be other variables that are “put in” or added to the monitor list by the user. Once a variable is in one of these lists, its value is updated whenever the program is halted and the debug windows are refreshed (i.e., when a trace is complete or a breakpoint is hit). This ensures that the variable values that are displayed are always current.

One problem with conventional debuggers is that they only display the variables that have changed since the last program halt so the user can see what has changed to the variable. As a result, it is not obvious to the user by looking at a program statement which variables in the program may change value when execution of the program is resumed after a program halt. By the time the program statement is executed it is often too late for the user to take action to make the proper problem determination. When this occurs, the user must allow the program to run until the situation of interest reoccurs or the user must re-run the program from the beginning. This can be a tedious and time-consuming process.

Therefore, there is a need for a method, article of manufacture and system adapted to address the problems associated with identifying which computer program variables are likely to change when debugging the computer program.

### SUMMARY OF THE INVENTION

The present invention generally provides an apparatus, program product, and a method for displaying variables from a program being debugged that has stopped executing.

In one embodiment, a computer system comprises an output device and at least one processor which, when executing a debugging program, is configured to wait for a program being debugged to stop executing immediately prior to executing a next executable statement at which at least one variable has a current value, and display on the output device the at least one variable in a manner that visually indicates an executable status of the at least one variable. The executable status is indicative of at least one of a use and change of the current value during subsequent continuing execution of the program being debugged.

Another embodiment provides a method for displaying variables of a program being debugged when the program being debugged stops executing immediately prior to executing a next executable statement at which at least one variable has a current value. The method comprises determining at least one of a first executable status and a second executable status of the at least one variable based on a current point of execution, wherein the first executable status is defined by whether the current value of the at least one variable may change during subsequent execution of the program being debugged and the second executable status is defined by whether the current value of the at least one variable has a use during subsequent execution of the program being debugged. An output is then prepared which, when displayed on an output device, visually indicates an executable status of the at least one variable at the current point of execution.

Yet another embodiment provides a method for displaying variables of a program being debugged, the method comprising, when a program being debugged stops executing immediately prior to a next executable statement at which at least one variable has a current value, determining an executable status of at least one variable of the statement based on a current point of execution. The executable status is indicative of at least one of a possible use and a possible change of the current value during subsequent continuing execution of the program being debugged. The method then prepares an output which, when displayed on an output device, visually indicates the executable status of the at least one variable at the current point of execution.

Still another embodiment provides a signal bearing medium, comprising a debugging program which, when executed by a processor, performs a method for displaying variables of the program being debugged. The method comprises, when a program being debugged stops executing immediately prior to a next executable statement at which at least one variable has a current value, determining an executable status of at least one variable of the statement based on a current point of execution The executable status is indicative of at least one of a possible use and a possible change of the current value during subsequent continuing execution of the program being debugged. The method then prepares an output which, when displayed on an output device, visually indicates the executable status of the at least one variable at the current point of execution.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a high-level diagram of a computer system consistent with the invention.

FIG. 2 illustrates a control flow graph.

FIG. 3 is a flow diagram of a debug interpreter illustrating user activation of inventive features.

FIG. 4 is a computer display displaying a graphical user interface configured with a variable window and a watch window.

FIG. 5 is a graphical user interface configured with a variable window.

### DETAILED DESCRIPTION OF THE PREFERRED EMBODIMENT

The present invention generally provides a method, apparatus and article of manufacture for debugging computer programs. In general, debugging computer programs is aided by determining an executable status of variables with regard to the subsequent statements to be executed. Subsequent statements may include only the next immediate executable statement and/or some number of executable statements. In one embodiment, an executable status indicates which variables in a computer program may be changed or have a use when the next statement(s) is executed. Such variables are referred to herein as “interesting variables”. In another embodiment, debugging is aided by determining variables with a current definition having a use in any statement which may be executed from a current location. Such variables are referred to herein as “live variables”. The resulting information can be processed to return meaningful data to a user including, for example, a list of interesting variables and/or live variables. In another embodiment, a list of variables is displayed on a monitor window wherein the variables are variables that will never be changed or used during continued execution of the program from the current location.

The program modules that define the functions of the present embodiments may be placed on a signal-bearing medium. The signal bearing media, include, but are not limited to, (i) information permanently stored on non-writable storage media, (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, object, module or sequence of instructions will be referred to herein as computer programs, or simply programs. The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention.

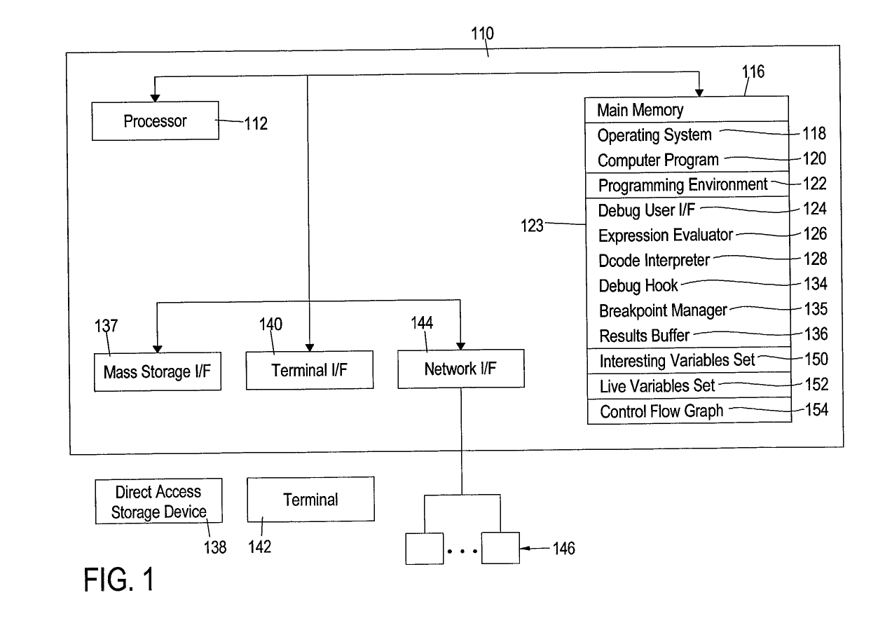

A particular system for implementing the present embodiments is described with reference to FIG. 1. However, those skilled in the art will appreciate that embodiments may be practiced with any variety of computer system configurations including hand-held devices, multiprocessor systems, microprocessor-based or programmable consumer electronics, minicomputers, mainframe computers and the like. The embodiment may also be practiced in distributed computing environments where tasks are performed by remote processing devices that are linked through a communications network. In a distributed computing environment, program modules may be located in both local and remote memory storage devices.

In addition, various programs and devices described hereinafter may be identified based upon the application for which they are implemented in a specific embodiment of the invention. However, it should be appreciated that any particular program or device nomenclature that follows is used merely for convenience, and the invention is not limited to use solely in any specific application identified and/or implied by such nomenclature.

Referring now to FIG. 1, a computer system 110 consistent with the invention is shown. For purposes of the invention, computer system 110 may represent any type of computer, computer system or other programmable electronic device, including a client computer, a server computer, a portable computer, an embedded controller, etc. The computer system 110 may be a standalone device or networked into a larger system. In one embodiment, the computer system 110 is an eServer iSeries 400 computer available from International Business Machines of Armonk, N.Y.

The computer system 110 could include a number of operators and peripheral systems as shown, for example, by a mass storage interface 137 operably connected to a direct access storage device 138, by a video interface 140 operably connected to a display 142, and by a network interface 144 operably connected to a plurality of networked devices 146. The display 142 may be any video output device for outputting a user interface. The networked devices 146 could be desktop or PC-based computers, workstations, network terminals, or other networked computer systems.

Computer system 110 is shown for a programming environment that includes at least one processor 112, which obtains instructions, or operation codes, (also known as opcodes), and data via a bus 114 from a main memory 116. The processor 112 could be any processor adapted to support the debugging methods, apparatus and article of manufacture of the invention. In particular, the computer processor 112 is selected to support monitoring of memory accesses according to user-issued commands. Illustratively, the processor is a PowerPC available from International Business Machines of Armonk, N.Y.

The main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in a computer system 110, for example, any storage capacity used as virtual memory or stored on a mass storage device or on another computer coupled to the computer system 110 via bus 114.

The main memory 116 includes an operating system 118, a computer program 120 (to be debugged), and a programming environment 122 comprising a debugger program 123, interesting variables sets 150, live variables sets 152 and a Control Flow Graph (CFG) 154. The programming environment 122 facilitates debugging the computer program 120, or computer code, by providing tools for locating, analyzing and correcting faults. One such tool is a debugger program 123 (also referred to herein as the debugger). In one embodiment, the debugger 123 is a VisualAge for C++ debugger modified according to the invention. VisualAge for C++ for OS/400 is available from International Business Machines of Armonk, N.Y. In a specific embodiment, the debugger 123 comprises a debugger user interface 124, expression evaluator 126, Dcode interpreter 128 (also referred to herein as the debug interpreter 128), debugger hook 134, a breakpoint manager 135 and a result buffer 136. Although treated herein as integral parts of the debugger 123, one or more of the foregoing components may exist separately in the computer system 110. Further, the debugger may include additional components not shown.

A debugging process is initiated by the debug user interface 124. The user interface 124 presents the program under debugging and highlights the current line of the program on which a stop or error occurs. The user interface 124 allows the user to set control points (e.g., breakpoints and watch points), display and change variable values, and activate other inventive features described herein by inputting the appropriate commands. In some instances, the user may define the commands by referring to high-order language (HOL) references such as line or statement numbers or software object references such as a program or module name, from which the physical memory address may be cross referenced.

The expression evaluator 126 parses the debugger command passed from the user interface 124 and uses a data structure (e.g., a table) generated by a compiler to map the line number in the debugger command to the physical memory address in memory 116. In addition, the expression evaluator 126 generates a Dcode program for the command. The Dcode program is machine executable language that emulates the commands. Some embodiments of the invention include Dcodes which, when executed, activate control features described in more detail below.

The Dcode generated by the expression evaluator 126 is executed by the Dcode interpreter 128. The interpreter 128 handles expressions and Dcode instructions to perform various debugging steps. Results from Dcode interpreter 128 are returned to the user interface 124 through the expression evaluator 126. In addition, the Dcode interpreter 128 passes on information to the debug hook 134, which takes steps described below.

After the commands are entered, the user provides an input that resumes execution of the program 120. During execution, control is returned to the debugger 123 via the debug hook 134. The debug hook 134 is a code segment that returns control to the appropriate user interface. In some implementations, execution of the program eventually results in an event causing a trap to fire (e.g., a breakpoint is encountered). Control is then returned to the debugger by the debug hook 134 and program execution is halted. The debug hook 134 then invokes the debug user interface 124 and may pass the results to the user interface 124. Alternatively, the results may be passed to the results buffer 136 to cache data for the user interface 124. In other embodiments, the user may input a command while the program is stopped causing the debugger to run a desired debugging routine. Result values are then provided to the user via the user interface 124.

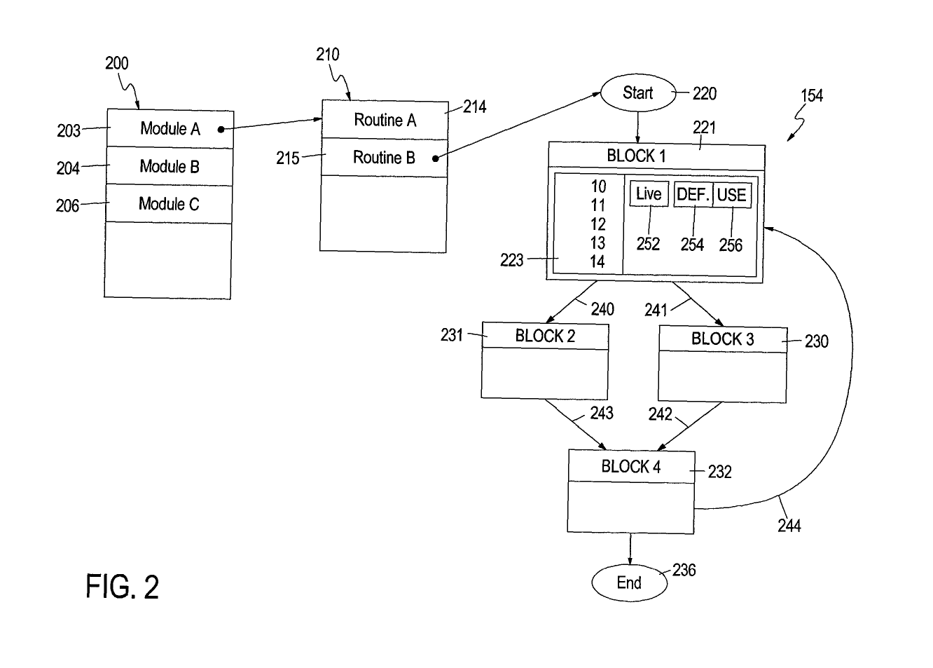

In some embodiments, the debugger 123 utilizes the CFG 154 to advantage. In particular, the CFG 154 is used to locate the next executable statement(s) from which an interesting variables set and a live variables set for a particular statement(s) is obtained. In general, the CFG 154 contains blocks of executable computer program statements. The blocks are constructed during the compilation of computer program 120 by a compiler (not shown) known in the art. One illustration of the CFG 154 is shown in FIG. 2 which is now described. Those skilled in the art will appreciate that even though FIG. 2 is described in terms of statically compiled and bound languages, these concepts can also be applied to dynamically bound languages such as Java without deviating from this invention. Additional information regarding compilers and related data structures may be found in Compilers: Principles, Techniques, and Tools; Alfred V. Aho, Ravi Sethi, Jeffery D. Ullman; Addison-Wesley Publishing Company 1986.

Within program 120, the CFG 154 and related information is anchored by (pointed to or referenced by) a module list 200. As known in the art, each module is a separate compilation unit. These units start out in a form commonly known as a source file. Source files can be written in one of many computer languages, such as but not limited to C, C++, or ADA. These source files are then converted to object by a program called a compiler. The compiler processes the source file through a process known in the art as compilation and produces output commonly known as an object file. The object files are then linked together to produce program 120. The compiler also constructs the CFG 154 and the interesting variable set 150 and live variable set 152. The CFG 154 and the sets 150,152 are then used by the debugger 123 according to embodiments of the invention.

The Module list 200 contains a plurality of one or more module records 203, 204, and 205. One record is provided for each object file or module used to build the program 120. Because each module can contain multiple routines (procedures or methods), each module record refers to a routine list 210. The routine list 210 contains a plurality of records, one for each routine in the module. Each record 214, through 215 in the routine list contains the name of the routine, and a reference to the CFG constructed for that routine.

CFG 154 comprises a start node 220 and an end node 236, and intermediary nodes 221, 230, 231, and 232, which are known in the art as basic blocks. A basic block is a sequence of consecutive statements in which flow of control enters at the beginning and leaves at the end without halt or the possibility of branching except at the end. Call statements do not break a basic block and may be contained within a basic block. These basic blocks are linked by arcs 240, 241, 242, 243, and 244, which specify possible program control flow between the blocks.

Block 221 is representative of the structure of all the basic block nodes within CFG 220. Basic Block 221 contains a list of statements 223 that are the statements within program 120, module 203, and routine 215, that reside in block 221. List 223 contains statements 10,11,12,13,14.

Each statement in the statement list 223 has an associated interesting variables set 250 and a live variables set 252. For simplicity only statement 10 is shown having associated variable sets. The interesting variables set 250 further comprises one or both of a definition set 254 and a use set 256. The definition set 254 contains the variables which may be modified by the statement with which it is associated (e.g., statement 10 in the case of the definition set 254 shown). The use set 254 contains the variables whose values may be used (i.e., loaded or read) in the computation performed by the associated statement (e.g., statement 10 in the case of the use set 256 shown). The live variables set 252 contains all variables whose values may be used at some later point of execution of the program 120. Variables in the live set 252 for a statement are referred to as “live”. Variables not in a given set 252 are “dead”. Whether a variable is “interesting”, “live” and/or “dead” at a statement is referred to herein as its executable status at the statement. It should be emphasized that the executable status of a variable is dependent on a particular statement.

Each of the variable sets 252, 254 and 256 may be implemented as bit vectors, where one bit vector is provided for each statement with one bit per variable. In the case of a live variable set 254, a bit in the bit vector is set when the value of the associated variable may be used by subsequent continued execution of program 120. In the case of a definition set 254, a bit vector in the bit vector is set when the value of the associated variable may be modified. In the case of a use set 256, a bit vector in the bit vector is set when the value of the associated variable may be used.

Utilizing the information provided by the CFG 154, the debugger program 123 can locate a statement on which execution has been halted (e.g., due to a breakpoint). The debugger 123 can then determine the executable statuses for variables associated with subsequent statements, including the one on which execution has been halted (i.e., the current statement). This determination may be made with reference to the variable sets 252, 254 and 256 associated with a particular statement.

The use of the live variables set 252, the definition variables sets 254 and the use variables sets 256 can be illustrated with reference to Table I.

TABLE I

| | |
|---|---|
| 001 | foo(int i, j) |
| 002 | { |

| | |
|---|---|
| 003 | j = 1; |
| 004 | if ( i < 10) j = 5; |
| 005 | foo2(j); |

| | |
|---|---|
| 006 | } |

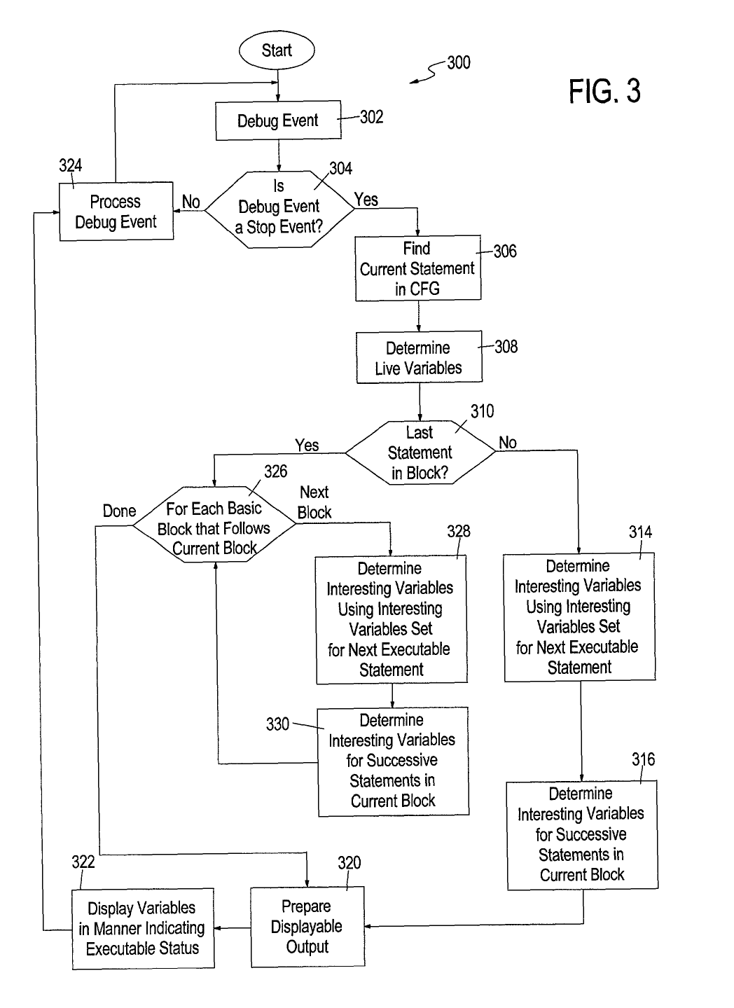

The C++ programming code listing in Table I illustrates a variable “j” which, at line 001, is passed to the routine “foo” with some unspecified value. If execution is halted at line 002 (i.e., just before executing line 002), “j” is both “dead” and “uninteresting”. That is, the variable is not included in any of the variable sets 252, 254 and 256 associated with line 002. The variable is dead because j's current value will not be used, since it will be changed at line 003. The variable is uninteresting because j's current value will not be changed or used at the current line, i.e., at line 002. (It is noted that in one embodiment a variable may be considered interesting (or semi-interesting) with respect to a statement(s) subsequent to the current statement, regardless of the variable's executable status with regard to the current statement. Such an embodiment is described below with reference to FIG. 3.) At line 003, j is assigned the value “1”. If execution is halted at line 003, prior to its execution, “j” is dead because it's current value will be changed at line 003 and is interesting because it will be defined at line 003. At line 004 “j” is live because its current value may be used at line 005 and interesting because it may be defined at line 004. At line 005 “j” is live and interesting because it's current value will be used at line 005. At line 006 “j” is dead and not interesting because it has no future use and will not be changed.

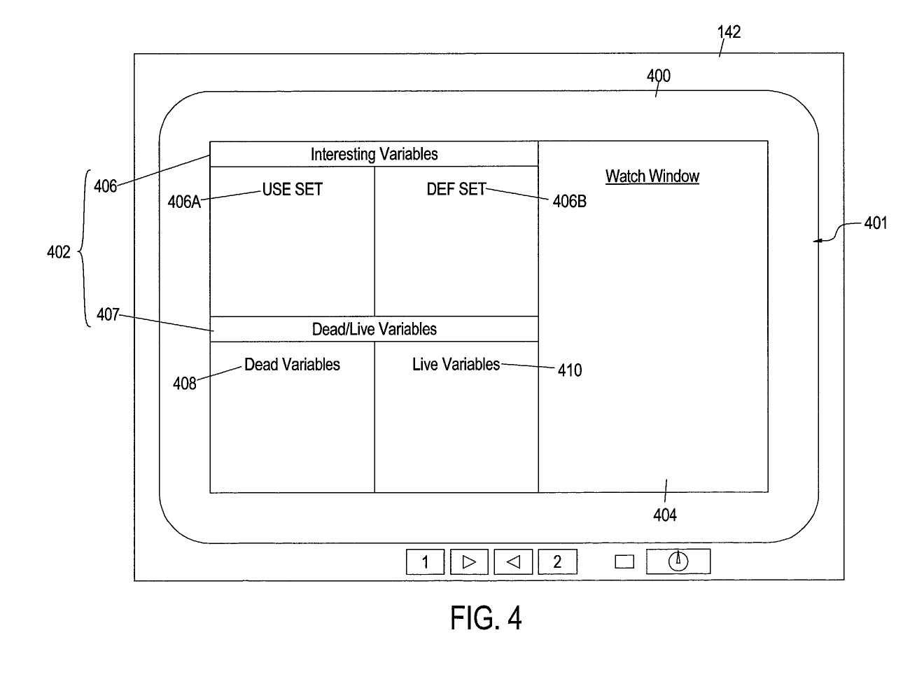

Once the executable statuses for one or more variables are known, the statuses can be displayed on the display 142. To this end, the debugger 123 may be configured to display a variables window and a watch window on the display 142 to allow management of variables in a program (e.g., program 120). Both windows may be made up of spreadsheet fields where information about the variables contained in a program is displayed. An illustrative monitor window 401 displayed on a screen 400 of the display 142 is shown in FIG. 4. In one embodiment, the monitor window 401 is an interface of the debugger program 123. In general, the window 401 comprises a variables window 402 and a watch window 404. The variables window 402 allows a user to keep track of variables important to the program's current context and provides quick access to those variables. The watch window 404 allows a user to choose which variables the user wants to “watch”. The variables window 402 includes an interesting variables set pane 406 and a live/dead variables pane 407. The variables set pane 406 is further divided into a use set frame 406A and a definition set frame 406B while the live/dead variables pane 407 is further divided into a live variables pane 408 and a dead variables pane 410. Each pane/frame may be populated using information contained in respective data structure, i.e., the interesting variables sets 150 and the live variables sets 152, respectively.

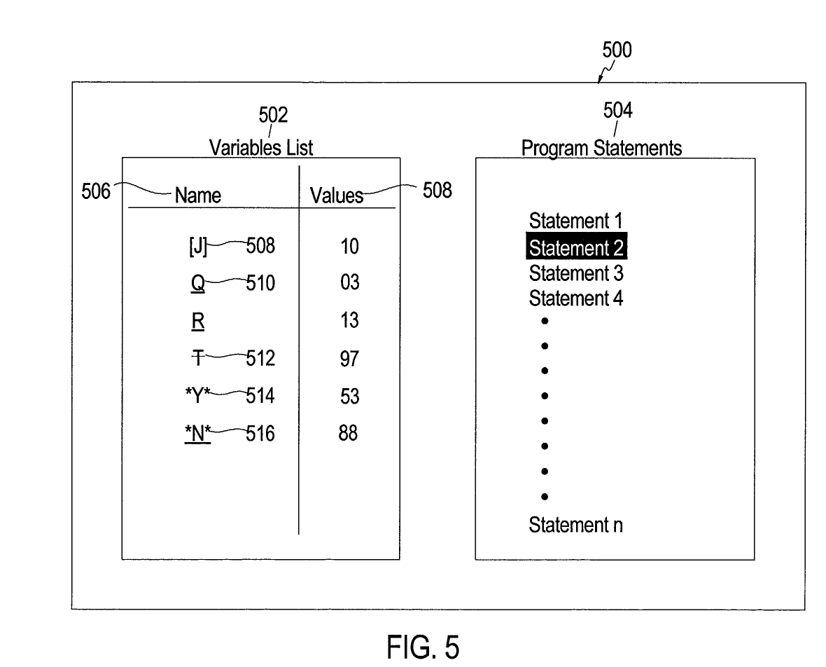

Conventionally, debuggers, such as the one packaged with Visual C++ from Microsoft Corporation, display only the variables that have changed since the last time the debugger has stopped. A debugger will typically stop the program when, for example, a pre-defined breakpoint has been reached or a step is completed. This allows a user to view the value of the variables of interest on the display 142. However in the conventional method, variables that are likely to have their value changed when the debugger resumes processing are not indicated to the user. Furthermore, variables that the compiler has identified as those that will never again have their current value used are not indicated to the user. Without this knowledge, by the time the debugger resumes processing, it is often too late for a user to act to make the proper problem determination. Accordingly, the present embodiments indicate the executable statuses of such variables to a user by placing the variables in separate panes, or highlighting or otherwise formatting the variables in the variables window. FIG. 4 shows an embodiment in which the variables are placed in separate panes to indicate their executable status. FIG. 5, described below, shows an embodiment in which the variables are formatted to indicate their executable statuses.

One embodiment illustrating a method of displaying variables to indicate their respective executable statuses is shown as a method 300 in FIG. 3. In one embodiment, the method 300 may be understood as illustrative of the operation of the system 110 under the control of the program 120 and the debugger 123. In general, method 300 determines an executable status of variables and then displays the variables in a manner to differentiate different executable statuses. Illustratively, the executable statuses of the variables are viewable by a user when a program under debug (e.g., program 120) has encountered a stop-processing event. The executable statuses indicate whether the variables are interesting variables (definition set variables or use set variables) or live set variables.

The method 300 is entered at step 302 whenever a debug event has occurred. At step 304, the method 300 queries if the debug event is a stop event. Illustratively, a stop event may be a breakpoint, completion of a step when using step processing, reaching a pre-set limit, or a user intervention event. If the event is not a stop event, the method 300 proceeds to step 324 where the debug event is handled according to predefined rules of the debug program 123. If the event is a stop event, the method proceeds to step 306 where the current computer program statement in the Control Flow Graph 154 is identified.

At step 308, the live variables for the current program statement are determined. In one embodiment, this determination is made by referencing the live variables set 252 for the current statement.

At step 310, the method 300 queries if the current statement is the last statement in the block. For example, the last statement may be a go-to statement where execution of computer program 120 is transferred to another block. The last statement may also be a conditional statement having three possible paths to three different blocks. The last statement may also be a non-branch statement in which case control falls through to the next block. In any case, the next executable statement will be the first statement in that block to which execution is transferred. If the current statement is not the last statement then the method 300 proceeds to step 314. Otherwise, the method 300 proceeds to step 326.

At step 314, the method 300 determines the interesting variable(s) for the statement of the program 120 to be executed next. An interesting variable is one whose value will be changed or used by the statement. In the former case, reference is made to the definition set 254 associated with the statement and in the latter case reference is made to the use set 256 associated with the statement.

At step 316, the interesting variables for a successive statement(s) in a block (i.e., the next statement(s) after the next executable statement handled at step 314) are determined. Again, reference is made to the definition set 254 and/or the use set 256 associated with each respective statement. From step 316 processing continues with step 320, which is described below.

Returning to step 326, the method 300 enters a loop for the immediately succeeding basic block that follows the current block and which contains the next executable statement. The locations of the block(s) are stored in the CFG 154 at the time of compilation of computer program 120. The method then proceeds to steps 328 and 330 for the immediately succeeding basic block. The processing at steps 328 and 330 is the same as that described with reference to steps 314 and 316, respectively. From step 330 processing returns to step 326. This loop is repeated until the immediately succeeding basic block is located and traversed. Processing then continues with step 320.

At step 320, a display output is prepared for output to the display 142. In particular, the display output is prepared so that, when displayed, the executable status of the variables will be visually discernable by a user. At step 322 the variables are displayed. In one embodiment, the variables are shown in a sorted list, e.g., with the live variables at the top and the dead variables at the bottom of the list. In other embodiments, the variables may be displayed in inverse video, a unique color, underlined, bold text, with icons or in any other way that would indicate the executable status of the variables to the user. In another embodiment, the variables may be displayed on the display 142 in a manner to differentiate the interesting variables from the live/dead variables.

In the foregoing embodiment, the processing at steps 316 and 330 provides a degree of anticipation greater than is provided by examining only the immediately successive executable statement at steps 314 and 328. Illustratively, the anticipation to determine interesting variables at steps 316, 330 is limited to variables that are used or defined before the end of the block containing the next executable statement. However, more generally, any degree of anticipation is contemplated. For example, a fixed number of statements or blocks may be examined. In any case, variables whose value may change or whose current value may be used in a statement subsequent to the immediately following statement (i.e., the next executed statement when execution of the program resumes) are referred to herein as “semi-interesting”, in order to distinguish such variables from the “interesting” variables associated with the next statement to be executed.

Embodiments of displaying the variables are illustrated with reference to FIG. 5. FIG. 5 shows an illustrative variables window 500, which may be configured to contain interesting variables, live variables and/or dead variables. In general, the window 500 comprises a variables list 502 and a program statements list 504. The variables list 502 includes a “Name” column 506 and a “Value” column 508. The “Name” column 506 holds the names of variables, and a “Value” column 508 holds each variable's value. The indicators in either column can be changed while the program is running. The program statements list 504 displays the program statements of a program being debugged (e.g., program 120). Typically, when the program stops executing, the next statement to be executed in the program is displayed in a manner that highlights the statement. Illustratively, “statement 2” is highlighted, indicating that execution has stopped at that statement. Accordingly, the variables list 502 contains the variables which may be affected when execution of the program resumes.

Each variable in the variables list 502 is formatted in a manner to indicate its executable status. That is, the formatting indicates to the user that the variables may be contained in the interesting variables set 150 and/or the live variables set 152 for a given statement. The particular manner in which they may be affected (e.g., defined or used) is indicated by visual characteristics. As an illustration, variables “J” 508, “Q” 510, “T” 512, “Y” 514 and “N” 516 are each displayed with a distinguishing characteristic (bracketed, underlined, strike-through, and contained by asterisks respectively). In this case, the brackets may represent a definition set variable, the underlining may represent a use set variable, the strike-through may indicate a dead variable and the asterisks may represent a live variable. The variable “N” 516 indicates a variable which is both live and interesting (included in the use set 256 for the current statement).

In other embodiments, the variables may be placed in different windows according to their respective executable states. Thus, interesting variables may be placed in a first window, live variables may be placed in a second window and dead variables may be placed in a third window. Such an embodiment is described above with reference to FIG. 4. Persons skilled in the art will recognize a variety of other methods to format and display the variables. These and other methods are all within the scope of the present invention.

In the foregoing embodiments, a compiler associates a “live set” with each statement of a procedure, indicating for each variable in the procedure whether it is live or dead following that statement's execution. Those skilled in the art will realize that this information could be represented in other forms that are within the scope of the invention. For example, a more compact way to represent the information is to associate a “becomes live” set and a “becomes dead” set with each statement. A variable “becomes live” in a statement if the statement writes a value to that variable that may be subsequently used. A variable “becomes dead” in a statement if the statement uses a value of that variable that will not be used subsequently. If these sets are used, the compiler must also provide a list of variables that are “live on entry” to the procedure (usually the formal parameters for the procedure). The debugger must then keep track of the currently live variables itself during program execution, starting with the live on entry variables at the beginning of the method and, when executing each statement, removing “becomes dead” variables from the list and adding “becomes live” variables to the list. In one aspect this approach may be less desirable than associating a single “live set” with each statement because the latter approach requires less work from the debugger. However, it should be recognized that other ways of representing a variable's executable status are possible.

While the foregoing is directed to embodiments of the present invention, other and further embodiments of the invention may be devised without departing from the basic scope thereof, and the scope thereof is determined by the claims that follow.

What is claimed is:

1. A computer system, comprising an output device and at least one processor which, when executing a debugging program, is configured to:
wait for a program being debugged to stop executing immediately prior to executing a next executable statement at which at least one variable has a current value; and
display on the output device the at least one variable in a manner that visually indicates an executable status of the at least one variable, wherein the executable status is indicative of at least one of a use and change of the current value during subsequent continuing execution of the program being debugged.

2. The system of claim 1, wherein the executable status indicates that the current value may change when the next executable statement is executed.

3. The system of claim 1, wherein the executable status indicates that the current value may be used when the next executable statement is executed.

4. The system of claim 1, wherein the executable status is visually represented on the output device to differentiate the at least one variable from other variables displayed on the output device.

5. The system of claim 1, further comprising a memory containing a monitor window interface configured to display the at least one variable on the output device in a manner to visually differentiate the at least one variable from other variables having a different executable status.

6. A method for displaying variables of a program being debugged, comprising:
when the program being debugged stops executing immediately prior to executing a next executable statement at which at least one variable has a current value, determining at least one of a first executable status and a second executable status of the at least one variable based on a current point of execution, wherein the first executable status is defined by whether the current value of the at least one variable may change during subsequent execution of the program being debugged and the second executable status is defined by whether the current value of the at least one variable has a use during subsequent execution of the program being debugged; and
preparing an output which, when displayed on an output device, visually indicates an executable status of the at least one variable at the current point of execution.

7. The method of claim 6, wherein the second executable status is defined according to one of only the next executable statement and any statement that may be encountered during subsequent execution of the program being debugged.

8. The method of claim 6, wherein the program being debugged stops executing upon encountering a breakpoint.

9. The method of claim 6, wherein determining comprises referring to a control flow graph.

10. The method of claim 6, wherein preparing comprises preparing the output so that, when displayed, the at least one variable is visually differentiable from other displayed variables according to their respective executable statuses.

11. The method of claim 6, wherein the first executable status indicates that the value of the at least one variable may change during subsequent execution of the program being debugged.

12. The method of claim 6, wherein the first executable status indicates that the value of the at least one variable may change during subsequent execution of the program being debugged and the second executable status indicates that the value of the at least one variable has a use during subsequent execution of the program being debugged.

13. The method of claim 6, wherein at least one variable is a variable referenced in the next executable statement in the program being debugged.

14. The method of claim 13, wherein the next executable statement contains a plurality of variables, and wherein preparing comprises preparing the output so that, when displayed, the at least one variable and the plurality of variables are visually differentiable from one another according to their respective different executable statuses.

15. The method of claim 6, further comprising displaying the variables with formatting to visually differentiate the variables from one another according to their respective executable statuses.

16. The method of claim 15, wherein the formatting comprises at least one of brackets, parentheses, asterisks, highlighting, strike-outs and numerals.

17. A method for displaying variables of a program being debugged, comprising:
when a program being debugged stops executing immediately prior to a next executable statement at which at least one variable has a current value, determining an executable status of at least one variable of the statement based on a current point of execution, wherein the executable status is indicative of at least one of a possible use and a possible change of the current value during subsequent continuing execution of the program being debugged; and
preparing an output which, when displayed on an output device, visually indicates the executable status of the at least one variable at the current point of execution.

18. The method of claim 17, wherein the executable status is defined according to one of only the next executable statement and any statement that may be encountered during the subsequent continuing execution of the program being debugged.

19. The method of claim 17, wherein the program being debugged stops executing upon encountering a breakpoint.

20. The method of claim 17, wherein a first executable status indicates that the value may change and a second executable status indicates that the value has a use.

21. The method of claim 17, wherein preparing comprises preparing the output so that, when displayed, the at least one variable is visually differentiable from other displayed variables according to their respective executable statuses.

22. The method of claim 17, wherein the next executable statement contains a plurality of variables, and wherein preparing comprises preparing the output so that, when displayed, the at least one variable and the plurality of variables are visually differentiable from one another according to their respective different executable statuses.

23. The method of claim 17, wherein the executable status indicates that the value of the at least one variable may have a use when execution of the program being debugged resumes and wherein preparing comprises preparing the output so that, when displayed, the variables are visually differentiable from one another according to their respective executable statuses.

24. The method of claim 17, wherein the executable status indicates that the value of the at least one variable may change when execution of the program being debugged resumes and wherein preparing comprises preparing the output so that, when displayed, the variables are visually differentiable from one another according to their respective executable statuses.

25. The method of claim 17, wherein determining comprises:
referring to a control flow graph to locate the next executable statement; and
accessing a variable-containing data structure associated with the next executable statement.

26. The method of claim 17, wherein determining further comprises:
referring to the control flow graph to locate an executable statement subsequent to the next executable statement; and
accessing a variable-containing data structure associated with the executable statement.

27. The method of claim 17, further comprising displaying the variables with formatting to visually differentiate the variables from one another according to their respective executable statuses.

28. The method of claim 27, wherein the formatting comprises at least one of brackets, parentheses, asterisks, highlighting, strike-outs and numerals.

29. A signal bearing medium, comprising a debugging program which, when executed by a processor, performs a method, comprising:
when a program being debugged stops executing immediately prior to a next executable statement at which at least one variable has a current value, determining an executable status of at least one variable of the statement based on a current point of execution, wherein the executable status is indicative of at least one of a possible use and a possible change of the current value during subsequent continuing execution of the program being debugged; and
preparing an output which, when displayed on an output device, visually indicates the executable status of the at least one variable at the current point of execution.

30. The signal bearing medium of claim 29, wherein the program being debugged stops executing upon encountering a breakpoint.

31. The signal bearing medium of claim 29, wherein determining comprises referring to a control flow graph.

32. The signal bearing medium of claim 29, wherein the executable status is defined according to one of only the next executable statement and any statement that may be encountered during the subsequent continuing execution of the program being debugged.

33. The signal bearing medium of claim 29, wherein preparing comprises preparing the output so that, when displayed, the at least one variable is visually differentiable from other displayed variables according to their respective executable statuses.

34. The signal bearing medium of claim 29, wherein a first executable status indicates that the value may change and a second executable status indicates that the value has a use.

35. The signal bearing medium of claim 29, wherein determining comprises:
referring to a control flow graph to locate the next executable statement; and
accessing a variable-containing data structure associated with the next executable statement.

36. The signal bearing medium of claim 35, wherein preparing comprises preparing the output so that, when displayed, the variables are visually differentiable from one another according to their respective executable statuses.

37. The signal bearing medium of claim 29, wherein the executable status indicates that the value of the at least one variable can change when execution of the program being debugged resumes.

38. The signal bearing medium of claim 37, wherein preparing comprises preparing the output so that, when displayed, the variables are visually differentiable from one another according to their respective executable statuses.

39. The signal bearing medium of claim 29, wherein the executable status indicates that the value of the at least one variable may have a use when execution of the program being debugged resumes and wherein preparing comprises preparing the output so that, when displayed, the variables are visually differentiable from one another according to their respective executable statuses.

40. The signal bearing medium of claim 29, wherein the next executable statement contains a plurality of variables, and wherein preparing comprises preparing the output so that, when displayed, the at least one variable and the plurality of variables are visually differentiable from one another according to their respective different executable statuses.

41. The signal bearing medium of claim 29, further comprising displaying the variables with formatting to visually differentiate the variables from one another according to their respective executable statuses.

42. The signal bearing medium of claim 41, wherein the formatting comprises at least one of brackets, parentheses, asterisks, highlighting, strike-outs and numerals.
